(19) United States
(12) Patent Application Publication
(10) Pub. No.: US 2012/0290573 A1
(43) Pub. Date: Nov. 15, 2012

(54) INFORMATION CAPTURING METHODS AND COMPONENTS

(76) Inventors: Alexander Kachkovsky, Maple Grove, MN (US); Oliver Kachkovsky, Jacksonville, FL (US)

(21) Appl. No.: 13/463,482

(22) Filed: May 3, 2012

Related U.S. Application Data
(60) Provisional application No. 61/485,328, filed on May 12, 2011.

(51) Int. Cl. G06F 17/30

(52) U.S. Cl. 707/736; 707/E17.009

(57) ABSTRACT

Capturing methods and components are provided. In one embodiment, a method includes identifying information to be captured. An electronic image of the information is generated. A file is identified, and the electronic image is associated with the file. The electronic image may be stored to the file and/or to a database. Other data (e.g. other textual or image data) may be stored along with the electronic image. Additionally, a determination may be made as to whether or not permission has been granted to use the information. If permission has not been granted, a request for permission is optionally generated.

### REFERENCE TO RELATED CASE

The present application is based on and claims the priority of provisional application Ser. No. 61/485,328 filed on May 12, 2011, the contents of which are hereby incorporated by reference in their entirety.

### BACKGROUND

When working on a task or a project, a person will commonly utilize information from multiple sources. For example, a person working on a business plan, a market analysis report, or an engineering design could utilize information from the Internet, e-mails, word processing documents, presentation files, spreadsheet files, catalogs, and from many other sources in completing the work. Sometimes the person may wish to save some of the information, or the person may wish to record an indication of where the information came from. In such a situation, the person could create a web link that is stored under “Favorites” in his or her web browser, or the person could “copy and paste” information from a source into a file such as a word processing document or spreadsheet file.

One particular type of task or project that a person may work on is a design project. For example, a person can use Computer Aided Design (“CAD”) or Computer Aided Manufacturing (“CAM”) software to design a product. Frequently, many of the components included in the design may come from outside vendors. For instance, a designer can select components from different vendors' online catalogs.

### SUMMARY

An aspect of the disclosure relates to information capturing methods and components. In one embodiment, a method includes identifying information to be captured, and generating an electronic image of the information. A file is then identified, and the electronic image is associated with the file. The electronic image may be stored to the file and/or to a database. Other data (e.g. other textual or image data) may be stored along with the electronic image. Additionally, a determination may be made as to whether or not permission has been granted to use the information. If permission has not been granted, a request for permission is optionally generated.

These and various other features and advantages that characterize the claimed embodiments will become apparent upon reading the following detailed description and upon reviewing the associated drawings.

### BRIEF DESCRIPTION OF THE DRAWINGS

FIG. 1 is a schematic diagram of an operating environment for capturing information.

FIG. 2 is a process flow diagram of a method of capturing information.

FIG. 3 is a process flow diagram of a method of using a permissions list when capturing information.

FIG. 4 is a screenshot of a user interface that can be used to capture information.

FIG. 5 is a screenshot of a user interface in which information to be captured has been highlighted.

FIG. 6 is a screenshot of a user interface of a stand-alone application for processing captured information.

FIG. 7 is a schematic diagram of an example of a computing device that can be used to implement certain embodiments of information capturing methods and components.

### DETAILED DESCRIPTION

Embodiments of the present disclosure include information capturing methods and components. Certain embodiments may assist people in capturing information from different sources such as, but not limited to, the Internet/Intranet, product catalogs, e-mails, word processing documents, and many other sources into one easily accessible, viewable, and searchable component. Additionally, the information may be added to a database that can provide a knowledge base to companies and/or individuals.

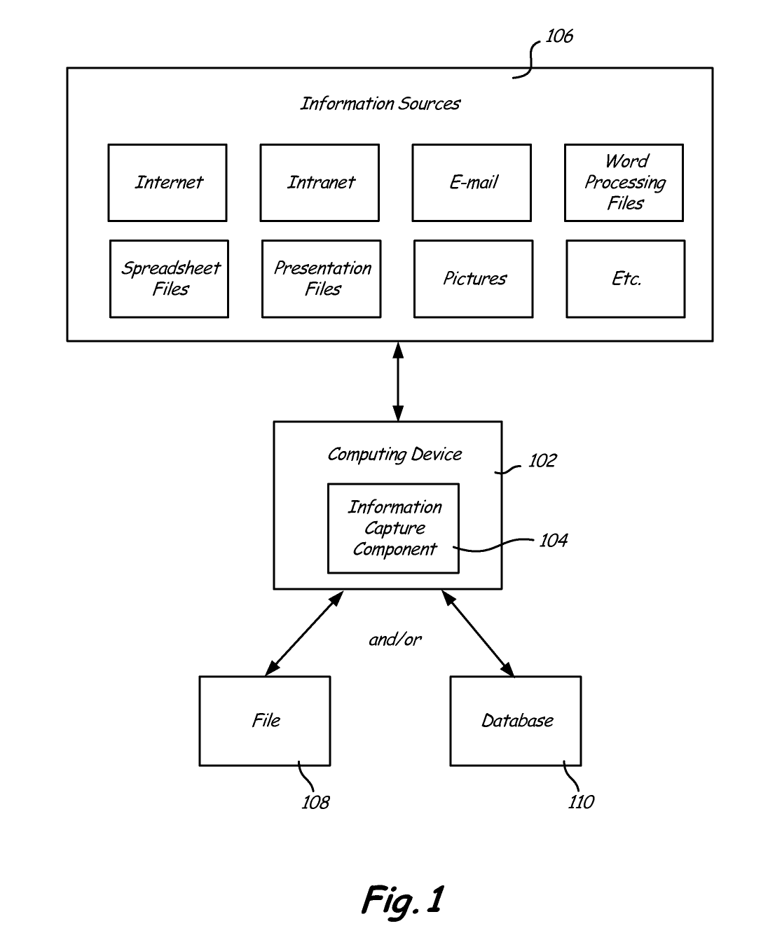

FIG. 1 is a schematic diagram of one illustrative operating environment in which certain embodiments of the present disclosure may be incorporated in. Embodiments of the present disclosure are not however limited to any particular operating environment and can be implemented in environments that differ from the specific example shown in FIG. 1.

In FIG. 1, a computing device 102 is communicatively coupled to a plurality of information sources 106. As is shown in the figure, some examples of information sources include the Internet, an intranet, electronic mail, word processor files, spreadsheets, presentation files, and picture files. Information sources 106 are not however limited to any particular type of information source, and can include any type of information source.

Computing device 102 optionally has a capture component 104. Capture component 104 may be implemented as a stand-alone software application or may be implemented as a plug-in for another software application. Capture component 104 illustratively captures information from one or more of the information sources 106, and stores the captured information to a file 108 and/or a database 110. The file 108 and/or database 110 can be stored locally on computing device 102, or can be stored remotely on another computing device. In either case, file 108 and/or database 110 may be made accessible such that their contents are accessible to both computing device 102 and to other computing devices.

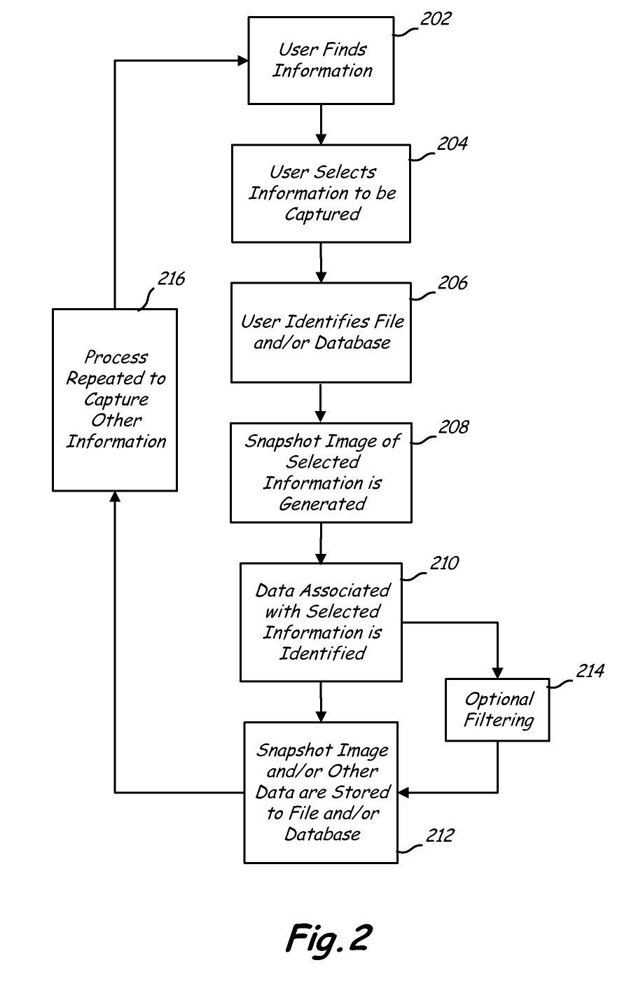

FIG. 2 is a process flow diagram of a method of capturing information. The method shown in FIG. 2 is illustratively implemented in the environment shown in FIG. 1. At block 202, a user finds information. For example, a person using computing device 102 can find information from any of the multiple information sources 106. At block 204, the user selects information to be captured. The information may be selected using capture component 104. In one particular embodiment, a user highlights information that is being displayed on a user interface. In another embodiment, a user selects or activates a window that is being displayed on a user interface. Or, in yet another embodiment, a user selects information by pressing a mouse button (e.g. a right mouse button) as the mouse cursor hovers above the information.

Once the information to be captured has been selected, at block 206, the user identifies a file and/or a database (e.g. file 108 and/or database 110) that is to be associated with the captured information. For instance, one or more interactive dialogue boxes may be presented on the user interface that enables the user to select a file and/or database. The user may wish for instance to associate the selected information with a CAD/CAM file, a word processing file, a spreadsheet, a presentation, or any other type of file and/or database.

At block 208, a snapshot image of the selected information is generated. A user may for example select an area that has both text and pictures. The capture component 104 would generate one image file (e.g. PNG, JPEG, GIF) that captures the entire selected area. Then, at block 210, data associated with the selected information/area is identified. For example, a selected area may have text, images, objects, and/or any other type of data within it. All of the different types of data are illustratively identified.

At block 212, the snapshot image and/or the data associated with the selected information are stored to the file and/or database identified at block 206. The snapshot image and/or the data may also be indexed at this time, so that it can later be searched for and retrieved. Sometimes, storing data to a file is referred to as adding third party storage. Embodiments of the present disclosure can illustratively be used with files that support third party storage and/or files that support other storage methods. In another embodiment, the snapshot image and the data are stored in another file (i.e. not stored to the filed identified at block 206). For example, data can be stored in a file type other than a CAD file, and be associated with a CAD file utilizing a database reference.

In one embodiment, the snapshot image and/or the data are stored or attached to the file and/or database utilizing stream methods. Stream methods can be used for example with files such as, but not limited to, MS Word, MS Excel, SolidWorks part files, and others. In some circumstances, a file stream is defined as a sequence of bytes. In an NFTS file system, streams contain data that is written to a file, and that gives more information about a file than attributes and properties. For example, a stream can be created that includes search keywords or the identify of a user account that creates the file.

Each stream that is associated with a file illustratively has its own allocation size, actual size, and valid data length. The allocation size is the amount of disk space that is reserved for a stream. The actual size is the number of bytes that are being used by a caller, and the valid length (“VDL”) is a number of bytes that are initialized from the allocation size for the stream. Each stream also maintains its own state for compression, encryption, and sparseness. The sparse attribute on the file is set if any of the streams have ever been sparse. Moreover, there may be no file times associated with the stream, and the file times for a file are updated when any stream in a file is updated.

Additionally, a capture component may utilize a compound document standard when storing data at block 212. A compound document is an electronic file that can functionally combine different sources of information into a single document. Embodiments of the present disclosure optionally utilize the compound document standard to embed the selected information into any standard document that conforms to the compound document standard. This may be beneficial in allowing for data to be associated with an un-opened document quickly. Additionally, in some circumstances a document may already be opened, in such a case, a capturing component may include a plug-in to facilitate writing to the opened document. This may be useful for example for MS Word, MS Excel, MS PowerPoint, MS Outlook, SolidWorks, Inventor, and AutoCAD files.

As is shown in FIG. 2, the method optionally includes a filtering step at block 214. In certain circumstances, a user may not wish to store all of the selected information. A user may for example not want to store advertising information. Any unwanted information is illustratively filtered out at block 204. In one embodiment, information to be filtered out may be identified based upon its location. For instance, a website may be known to include banner advertisements at the top of it pages. In such a case, the top banner advertisements can be filtered out. Accordingly, when the data is stored at block 212, it may include filtered data and not necessarily all of the data in the selected area.

At block 216, the process shown in FIG. 2 is optionally repeated. This means that the user may find and select information from multiple different sources, and/or the user may find and select different pieces of information from a same source. All of the multiple selected pieces of information can optionally be stored to one file and/or database. For example, a complex engineering design project may use components from multiple different vendors. Each of the different vendors may have individual webpages that include pictures of their components and specifications for their components. The method shown in FIG. 2 can illustratively be used to store information from all of the different webpages.

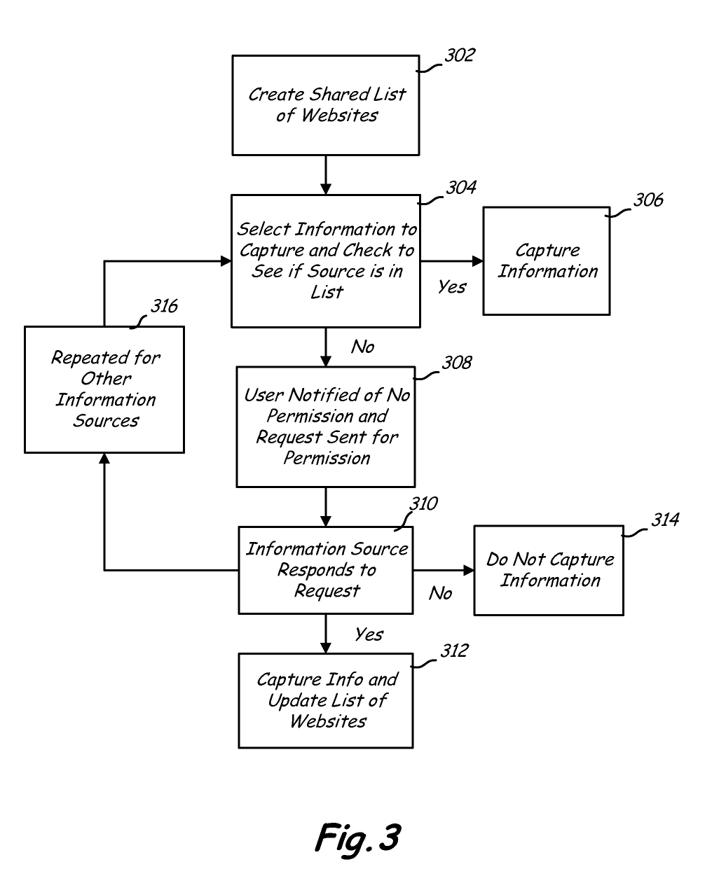

FIG. 3 is a process flow diagram of a method of using a permissions list when capturing information. At block 302, an initial shared list or database of websites is created. It optionally lists website information for which the owner of the protected information agrees to allow creating snapshots of his or her website and agrees to allow collecting of text, images, and other data. The list may also specify uses for which the permission is granted. A website owner may for instance grant permission for any use, or may grant permission for one or more limited uses (e.g. educational and/or research uses only).

At block 304, a user selects information to capture, and the initial shared list of websites is checked to see if the source of the selected information is in the list. If the source is in the list, then at block 306 the selected information is captured. If the source is not in the list, then at block 308 the user is optionally prompted with a message that informs him or her that the website has not approved the use of the information. Also at block 308, a request (e.g. an e-mail message) is optionally sent to the information source to request permission to use the identified information. In one embodiment, the request is automatically sent upon a determination that the information source is not in the list.

At block 310, the information source responds to the request. If permission is granted, then at block 312, the information is captured. Also, the website is added to the shared list of websites, and a message notifying the user that permission has been granted is transmitted to the user. If permission is not granted (i.e. permission is refused), then at block 314, the information is not captured. Also, the user is notified of the refusal, and the website is not added to the shared list of websites. This process is then repeated as desired at block 315 for additional information sources.

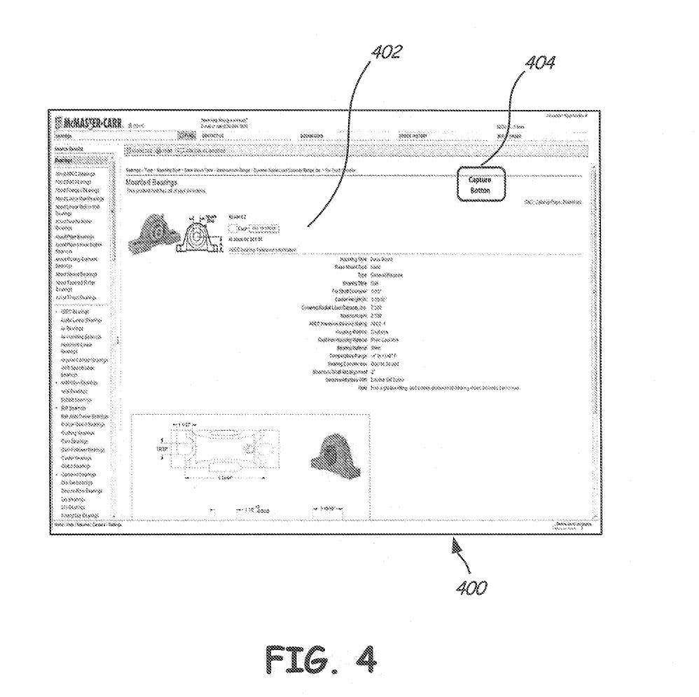

FIGS. 4, 5, and 6 illustrate examples of some possible user interfaces that could be used to implement embodiments of the present disclosure. FIG. 4 shows a user interface 400. Interface 400 includes information 402 from an information source. The information 402 may include image data, textual data, and any other type of data. In one embodiment, such as in the one shown in the figure, the information 402 is from an online catalog. Information 402 is not however limited to any particular type of source, and can include information from any source.

User interface 400 may also include a capture button 404. Capture button 404 is illustratively separate from information 402 such that button 404 is displayed in user interface 400 as information 402 changes (e.g. a user may browse different websites within interface 400).

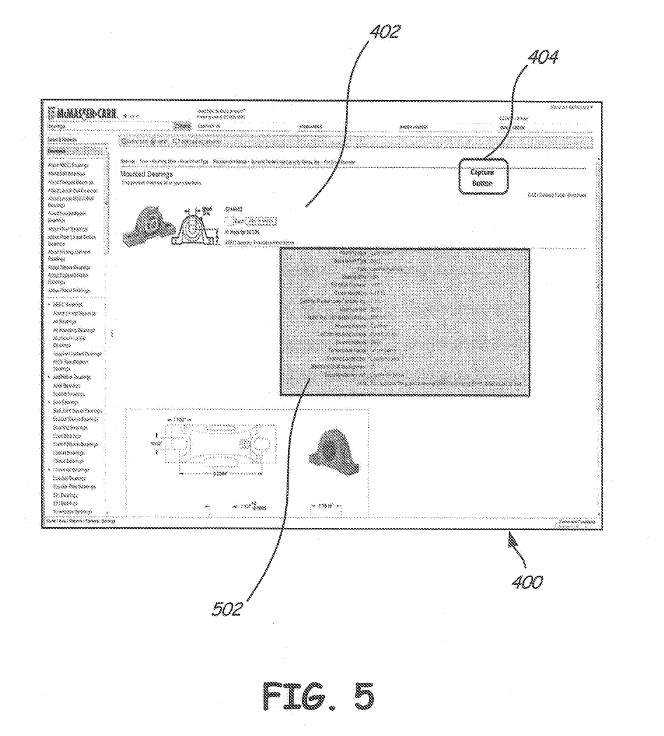

FIG. 5 shows user interface 400 after capture button 404 has been actuated. Actuation of capture button 404 illustratively enables a user to select a portion of the user interface 400 that he or she would like to capture. For instance, in FIG. 5, a user has selected to capture the information included within the box 502. Box 502 can be expanded or contracted as needed such that only the desired information is highlighted. Additionally, the shape of box 502 is not limited to only being a rectangle, but can be any shape. As has been described above, once the desired information is selected, a snapshot image of the selected information is optionally created and saved, and the information included within the area (e.g. text, pictures, etc.) is also optionally saved.

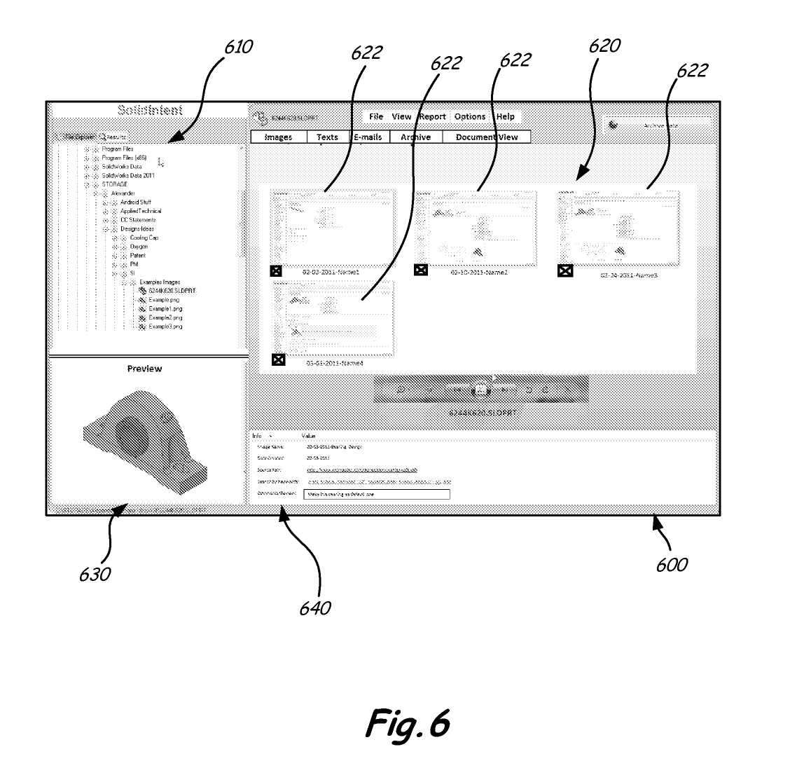

FIG. 6 shows a user interface 600 of a stand-alone application for processing captured information. Interface 600 includes a file browsing portion 610, a thumbnails portion 620, a preview portion 630, and a details portion 640. In an embodiment, files can be organized using folders and subfolders, and a user is able to browse and select a file using the file browsing portion 610. In the particular example shown in FIG. 6, a user has selected the file “6244K620.SLDRT” that is in the “Example Images” folder.

Once a file has been selected, thumbnail images 622 that are associated with the file are displayed in thumbnails portion 620. For instance, in the example shown in FIG. 6, a user has previously used the information capturing methods described above to capture and associate four pieces of information with the file “6244K620.SLDRT.” The thumbnail images 622 may be generated using snapshot images. The thumbnail images 622 may also have corresponding names displayed in portion 620. For example, the images 622 in FIG. 6 are named “02-03-2011-Name1,” “02-10-2011 -Name2,” “02-24-2011-Name3,” and “03-01-2011-Name4.”

Preview portion 630 optionally displays a preview of an image. For example, upon a user selecting one of the thumbnail images 622, a larger image associated with the selected thumbnail is shown in preview portion 630. In the particular example shown in FIG. 6, the thumbnail “02-03-2011-Name1” has been selected as is indicated by the shaded border surrounding the thumbnail. The image shown in preview portion 630 illustratively corresponds to the selected thumbnail.

Details portion 640 optionally displays additional information. For instance, portion 640 may show additional information about a file selected from portion 610 and/or additional information about a thumbnail selected from portion 620. In the example shown in the figure, the additional information includes an image name, a creation date, a source path, keywords, and user comments. Details portion 640 can illustratively display any additional information that may be desired, and is not limited to the specific types of information shown in FIG. 6.

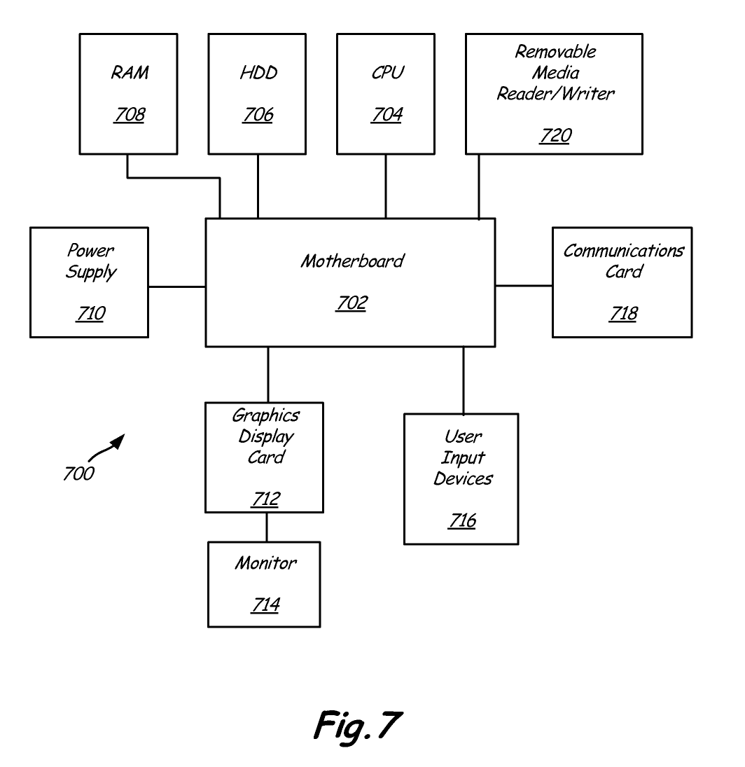

Certain embodiments of the present disclosure are intended for implementation in association with a computing device such as, but not limited to, a personal computer, a laptop computer, a tablet, a smartphone, or a personal digital assistant. FIG. 7 is a block diagram of one example of a suitable computing device 700. Computing device 700 is only one example of a suitable device and is not intended to suggest any limitation as to the scope of use or functionality of the claimed subject matter. Neither should computing device 700 be interpreted as having any dependency or requirement relating to any one or combination of illustrated components.

Computing device 700 includes a motherboard 702, a central processing unit 704, a hard disk drive 706, random access memory 708, a power supply 710, a graphics display card 712, a monitor 714, user input devices 716, a communications card 718, and removable media reader/writer 720. Hard disk drive 706 is configured to write information to, and read information from computer readable storage media. Random access memory 708 is also configured to write information to, and read information from computer readable storage media. Removable media reader/writer 720 is configured to write information to, and read information from removable media such as, but not limited to, a magnetic disk, an optical disk, and/or flash memory. User input devices 716 are configured to receive various inputs from a user. Devices 716 can include, but are not limited to, a keyboard, a mouse, a touch screen, and/or a microphone. Communications card 718 enables computing device 700 to transfer data to and from other electronic devices.

Graphics display card 712 generates graphical image information and outputs the information such that it can be viewed on a monitor. Monitor 714 receives a signal from graphics display card 712 and displays visual images on its screen for a user to view. Central processing unit 704 executes computer program instructions and processes data. Motherboard 702 provides electrical and logical connections by which the other components of the system communicate. For example, motherboard 702 allows the central processing unit 704 to read data from, and write data to random access memory 708. Finally, power supply 710 provides for the electrical requirements of computing device 700. For example, electricity needed to operate hard disk drive 706 and monitor 714 illustratively originates from power supply 710.

Those skilled in the art will appreciate that embodiments of the present disclosure may be advantageous in many situations. For example, in life today, people deal with different types of data. This data can range from text, images, diagrams, graphs, etc. If data has value to a user, the user may want to store that data. The collection and storing of this data could relate to personal interests, a specific topic of research, documentation development process, or any other purpose. Therefore, there is a need for the information capturing methods and components described above, which will assist people in capturing desired data from different sources such as the Internet/Intranet, product catalogs, e-mails, word documents, and any other source into one easily accessible, viewable, and searchable application. Additionally, the data may be added to a database which will provide knowledge base to other people, companies, organizations, and the like.

In one embodiment, a person is tasked to develop a document such as, but not limited to, a business plan or market analysis. He or she may start by searching for relative information from different sources (e.g. the Internet and/or Intranet). After the needed information is located and reviewed, the user can use embodiments of the present disclosure to capture, group, and store the information to a custom database. As soon as the data is captured, other users can access that data. For example, if an information capturing application is installed, other users can review, add comments, and/or regroup all of the captured information in real-time. Also the users can search the database or Internet for additional references based on the keywords that are stored with each collected record.

Accordingly, embodiments of the present disclosure will allow capturing, storing, and grouping a variety of different types of data to one specific document and propagate that data to a database. Embodiments therefore provide additional capabilities of capturing, recording, and grouping data, which also provide wider search capabilities.

In one particular implementation, embodiments can be used in engineering design. For example, in today's market, most engineering companies have a predefined design process. Before a designer can begin the 3D virtual prototyping process or 3D modeling, initial design parameters or design specifications must be created and evaluated. The design specifications define the design input information and can be used to review design changes and examine design outputs.

The initial design specifications may be represented by documents outside of a 3D model. These documents may only define initial parameters to start the design process. The next step in the design process is creating an initial 3D assembly model which defines the system's overall dimensions. Then, the detailed components are created and added to the assembly model file. Sometimes, around 80% of design components may come from outside vendors. Since there is a big market of commercially developed products, designers will search for those components and add them to the assembly model.

In an engineering design processes, the designers must make appropriate selections of commercially available components or systems which define the functionality for an expected design. In order to achieve these objectives, the designer conducts research using a wide area network or more local network (e.g., Internet/Intranet) accessing published information. Typically, this information is obtained through manufacturers' catalogs where the specifications and detailed critical dimensions are located. When an engineer makes a decision to use and integrate commercially available systems or components in a design, in many cases, the technical specifications may not be stored in the model file.

To make the design process more efficient for designers to access the product specifications, embodiments of the present disclosure can store the technical specifications directly to the part or assembly files. In at least some circumstance, it may be beneficial to make these stored specifications searchable within the software the designer is working on via a third party application. Currently, to access the desired specifications for an existing commercial component or assembly that a company uses, a designer must obtain a manufacturer's part number, which in many cases, is stored in a file description and then search for its specifications using, for example, the Internet/Intranet (go to the Web page in example above). Once the specification is located, it is studied and could be printed. The specification however is normally not stored. When the specification needs to be accessed again or presented during the design review, many designers go through the redundant process of finding the information which is a time consuming practice.

Therefore, one possible advantage of embodiments of the present disclosure is that they will assist designers in capturing desired data from the Internet/Intranet, product catalogs, e-mails, word documents, and many other sources into one easily accessible, viewable, and searchable “document”/file/etc. The captured data could be as broad as a MS Excel table or graph or slide from a MS PowerPoint presentation or page from a MS Word document. Another important source of information includes e-mail applications. A designer can choose e-mails which are important to the specification process and add them to the file.

The above described technique may also be used in design validation/review process that currently is time consuming due to the manual process. Design specifications that are stored directly to the model can be accessed and validated quickly against design requirements/inputs.

The importance of design reviews is understood in companies that deal with designs of any kind. The design reviews are conducted at strategic points in the work process. For example, a review is conducted to assure that the design requirements are adequate before they are converted into the final specifications. Another “go around” review is used to assure that the device design is adequate before prototypes are produced for testing. Later on, a validation review is conducted prior to transfer of the design to production. Generally all review times, are used to provide assurance that an activity or phase has been completed in an acceptable manner, and that the next activity or phase can begin.

An additional possible benefit is that by storing research information directly to the model, any designer or manager can review an obtained design specification at any time after the design is completed and treat those specifications as a knowledge base.

Furthermore, a capturing component may be implemented as an application that can provide users with its own file type. This will allow other groups in the corporations with the ability to collect, store, and group data outside of the CAD environment.

One easy way to review all of the information discussed above is to create a snapshot image. The snapshot image can be the main card of the application. The image could be used to preview the information and could activate a main source by a hyperlink connection when needed. This is an important concept because much of the needed data could be previewed from the image without loading the source file.

Additionally, another goal is to develop software for engineers who utilize CAD programs and provide designers with a powerful tool to store the design specifications to the 3D geometry quickly with a “mouse click” function. The search capability of stored data will guarantee that once the file is created, it could be easily located and utilized in new designs when desired parameters match with recorded specifications which will save time and effort for designers to complete designs and meet aggressive deadlines. New functionality will aid new engineers joining companies with ability to learn about existing designs not only by graphical illustrations the 3D software offers, but also by studying and understanding design specifications, and equipment operation principles, which could lead to a quicker learning about company products and services and therefore increase productivity and efficiency of a workforce.

It should also be noted that certain embodiments of the present disclosure can be used with a product data management (“PDM”) application. A PDM application manages files (e.g. file versions, security to access files, relationships between files, etc.) for file types such as SolidWorks, MS Word, PDF, or any other file types. A PDM application will commonly maintain a database of files and their relationships with each other. Through a PDM interface, a user can track associations of one file with the rest of the files. For example, a part document could have an association with a part drawing, and it would be a parent-child relationship. Or, if a part document has an association with a MS Word document, it would be a link relationship. A PDM application can be implemented as a plug-in for another application (e.g. SolidWorks, AutoCAD, MS Word, etc.) or can be implemented as a standalone application. In an embodiment, the capturing components and methods described above can utilize a PDM application. For instance, a PDM application can be utilized as a database (e.g. create a custom table in a PDM application) to store information and associate it with a file name or an ID. A user could then use PDM functionality to view specifications for related files.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
identifying information to be captured;
generating an electronic image of the information;
identifying a file; and
associating the electronic image with the file.

2. The method of claim 1, wherein associating the electronic image with the file comprises storing the electronic image to the file.

3. The method of claim 1, wherein associating the electronic image with the file comprises storing the electronic image to a database.

4. The method of claim 1, and further comprising:
identifying additional information to be captured, the additional information being from a different source than the original information;
generating an electronic image of the additional information; and
associating the electronic image of the additional information to the file such that the file is associated with two or more electronic images.

5. The method of claim 1, and further comprising:
identifying data that corresponds to the information; and
associating the data with the file.

6. The method of claim 5, wherein the data comprises textual data.

7. The method of claim 5, wherein the data comprises image data.

8. A method comprising:
identifying a collection of data;
generating an image of the collection of data;
identifying a file; and
storing at least a portion of the collection of data and the image to the file.

9. The method of claim 8, and further comprising:
storing the at least a portion of the collection of data and the image to a database.

10. The method of claim 8, and further comprising:
verifying whether or not permission to use the collection of data has been granted.

11. The method of claim 10, wherein verifying whether or not permission has been granted comprises comparing a name of a website associated with the collection of data to a shared list of websites.

12. The method of claim 11, and further comprising:
determining that permission has not been granted; and
sending a request for permission to use the collection of data.

13. The method of claim 12, and further comprising:
receiving permission to use the collection of data; and
updating the shared list of websites to include the name of the website associated with the collection of data.

14. A method comprising:
displaying a collection of information on a user interface;
selecting at least a portion of the collection of information;
generating an image corresponding to the selected portion; and
storing the image and an indication of a source of the collection of information to a file.

15. The method of claim 14, wherein the indication of the source of the collection of information includes an internet address.

16. The method of claim 14, and further comprising:
selecting the file; and
displaying a thumbnail of the image and thumbnails of other images that have been associated with the file.

17. The method of claim 16, and further comprising:
selecting one of the displayed thumbnails; and
displaying information about the selected thumbnail.

18. The method of claim 17, wherein the displayed information includes an image name, a creation date, a source path, keywords, and comments.

19. The method of claim 17, and further comprising:
displaying a preview of a component associated with the selected thumbnail in a preview section.

20. The method of claim 19, and further comprising:
simultaneously displaying the thumbnails, the information about the selected thumbnail, and the preview section at a same time.
